(19) United States
(12) Patent Application Publication
(10) Pub. No.: US 2018/0081557 A1
(43) Pub. Date: Mar. 22, 2018

(54) MEMORY MODULE COMMUNICATING WITH HOST THROUGH CHANNELS AND COMPUTER SYSTEM INCLUDING THE SAME

(71) Applicant: Samsung Electronics Co., Ltd., Suwon-si (KR)

(72) Inventors: Pavan Kumar KASIBHATLA, Suwon-si (KR); Hak-Soo YU, Seoul (KR); Seokin Hong, Cheonan-si (KR)

(73) Assignee: Samsung Electronics Co., Ltd., Suwon-si (KR)

(21) Appl. No.: 15/685,084

(22) Filed: Aug. 24, 2017

(30) Foreign Application Priority Data
Sep. 21, 2016 (KR) 10-2016-0120890

(51) Int. Cl. G06F 3/06; H04L 12/28

(52) U.S. Cl. CPC G06F 3/0607; G06F 3/0619; H04L 12/28; G06F 3/0656; G06F 3/0688

(57) ABSTRACT

Disclosed is a computer system which includes a host and a memory module. The host transfers a plurality of cache lines to a memory module through a plurality of channels, the cache lines including a plurality of data elements and allocates cache lines with target data elements in the plurality of data elements to one channel of the plurality of channels. The target data elements are arranged within the ache lines according to a stride interval. The stride interval is a number of data elements between consecutive ones of the target data elements. The memory module includes gather-scatter engines that are respectively connected to the plurality of channels and scatter or gather the target data elements under control of the host.

### CROSS-REFERENCE TO RELATED APPLICATIONS

A claim for priority under 35 U.S.C. § 119 is made to Korean Patent Application No. 10-2016-0120890 filed Sep. 21, 2016, in the Korean Intellectual Property Office, the entire contents of which are hereby incorporated by reference.

### BACKGROUND

Example embodiments of the inventive concepts disclosed herein relate to a memory module and a computer system, and more particularly, to a memory module that communicates with a host through a plurality of channels and a computer system including the same.

In general, a computer system may include a host and a memory module. A host may include a processor. The processor may store an operation - suit in the memory module. An operating speed of the processor may be faster than a data input-'output speed of the memory module. In this case, since the memory module fails to support the operating speed of the processor, the memory module has an influence on the whole performance of the computer system.

To overcome the above-described issue, the number of channels between the host and the memory module may increase. For this reason, there is a need for a computer system that efficiently uses the channels between the host and the memory module.

### SUMMARY

Example embodiments of the inventive concepts provide a memory module that communicates with a host through a plurality of channels and a computer system including the same.

According to an aspect of an example embodiment, a computer system includes a host and a memory module. The host transfers a plurality of cache lines composed of a plurality of data elements to a memory module through a plurality of channels and allocates cache lines, with target data elements in the plurality of data elements, to one channel of the plurality of channels. The target data elements are being arranged within the cache lines according to a stride interval. The stride interval is a number of data elements between consecutive ones of the target data elements. The memory module includes gather-scatter engines that are respectively connected to the plurality of channels and scatter or gather the target data elements under control of the host.

According to another aspect of an example embodiment, a memory module includes a plurality of memory areas and a plurality of gather-scatter engines. The plurality of memory areas are respectively connected with the plurality of channels. The plurality of gather-scatter engines are respectively connected with the plurality of channels and respectively connected with the plurality of memory areas. Under control of the host, each of the plurality of gather-scatter engines are configured to scatter target data elements through one of the plurality of channels such that the target data elements are stored in a memory area connected with the one channel of the plurality of channels, the target data elements are accessed based on a stride interval. The stride interval is a number of data elements between consecutive ones of the target data elements. The plurality of gather scatter engines are configured to transfer through one channel of the plurality of channels such that the target data elements are stored in a memory area connected with the one channel and transfers the target data elements from the memory area connected with the one channel of the plurality of channels.

A computer system includes a host configured to transfer a stream of data to a memory module through a plurality of channels, the stream of data divided into cache lines of bytes or larger, each line of data including a plurality of data elements of 2 bytes or larger, some of the data elements are target data elements that are dispersed among the stream of data at a regular interval, and allocate the data lines which include target data elements to one channel of the plurality of channels. The host also includes a memory module including gather-scatter engines that are respectively connected to the plurality of channels. The gather-scatter engines are configured to scatter the data elements into one of a plurality of memory areas or gather the target data elements from the one of the plurality of memory areas, under control of the host.

### BRIEF DESCRIPTION OF THE FIGURES

FIG. 1 is a block diagram illustrating a computer system, according to an example embodiment of the inventive concepts.

FIGS. 2 and 3 are drawings illustrating a data input/output operation performed in a computer system illustrated in FIG. 1.

FIG. 4 is a block diagram illustrating a computer system, according to an example embodiment of the inventive concepts.

FIG. 5 is a block diagram illustrating a host, according to an example embodiment of the inventive concepts.

FIG. 6 is block diagram illustrating a gather-scatter engine illustrated in FIGS. 1 to 4.

FIG. 7 is a block diagram illustrating a detailed example embodiment of a gather-scatter engine illustrated in FIG. 6.

FIG. 8 is a timing diagram illustrating an operation in which a memory module processes a gather-scatter command, according to an example embodiment of the inventive concepts.

FIG. 9 is a flowchart illustrating an operation sequence of a memory module, according to an example embodiment of the inventive concepts.

FIG. 10 is a flowchart illustrating an operation sequence of a memory module, according to an example embodiment of the inventive concepts.

FIG. 11 is a drawing illustrating an operation in which a scatter command is performed in a computer system, according to an example embodiment of the inventive concepts.

FIG. 12 is a drawing illustrating an operation in which a gather command is performed in a computer system, according to an example embodiment of the inventive concepts.

FIG. 13 is a block diagram illustrating an application of a computer system, according to an example embodiment of the inventive concepts.

### DETAILED DESCRIPTION

Below, example embodiments of the inventive concepts may be described in detail and clearly to such an extent that an ordinary one in the art easily implements the inventive concepts.

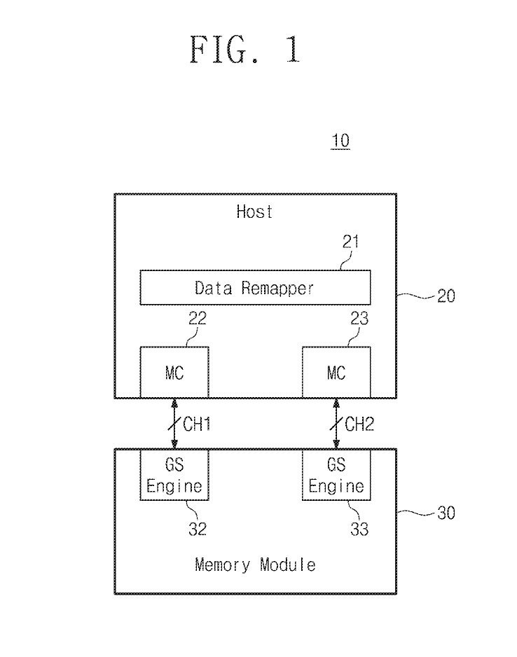

FIG. 1 is a block diagram illustrating a computer system, according to an example embodiment of the inventive concepts. Referring to FIG. 1, a computer system 10 may include a host 20 and a memory module 30. The host 20 may include a data remapper 21 and memory controllers (MC) 22 and 23. The memory module 30 may include gather-scatter (GS) engines 32 and 33.

Referring to FIG. 1, the host 20 and the memory module 30 may be connected to each other through two channels CH1 and CH2. Here, the number of channels is not limited to illustration. For example, example embodiments of the inventive concepts relate to a computer system in which the number of channels between the host 20 and the memory module 30 is at least two or more. The number of channels may be determined by the specification that defines communication between the host 20 and the memory module 30. The performance of data input/output between the host 20 and the memory module 30 may be improved more and more as the number of channels becomes larger. The host 20 may include the memory controllers 22 and 23 the number of which is the same as the number of channels. Likewise, the memory module 30 may also include the gather-scatter engines 32 and 33 the number of which is the same as the number of channels.

The host 20 and the memory module 30 may communicate with each other through the channels CH1 and CH2. An interface that is used for communication between the host 20 and the memory module 30 may be determined according to the protocol or specification. For example, the interface may be determined by various protocols such as universal serial bus (USB), advanced technology attachment (ATA), serial ATA (SATA), serial attached SCSI (SAS), parallel ATA (PATA), high speed interchip (HSIC), small computer system interface (SCSI), firewire, peripheral component interconnection (PCI), PCI express (PCIe), nonvolatile memory express (NVMe), universal flash storage (UFS), secure digital (SD), multimedia card (MMC), embedded MMC (eNEMC), etc.

The host 20 may drive elements and an operating system of the computer system 10. In an example embodiment, the host 20 may include controllers for controlling elements of the computer system 10, interfaces, graphics engines, etc. In an example embodiment, the host 20 may include a central processing unit (CPU), a graphic processing unit (GPU), a system on chip (SoC), an application processor (AP), or the like.

The data remapper 21 may be implemented with hardware or software. For example, the data remapper 21 may be implemented with a field programmable gate array (FPGA), an application specific integrated circuit (ASIC), or the like. The data remapper 21 may perform a mapping operation on data that is output from the host 20 to the memory module 30 or is received from the memory module 30. The data remapper 21 may determine whether to allocate data to any channel of the two channels CH1 and CH2. In more detail, the data remapper 21 may determine whether to allocate a plurality of cache lines to any channel of the two channels CH1 and CH2. Below, a cache line will be described,

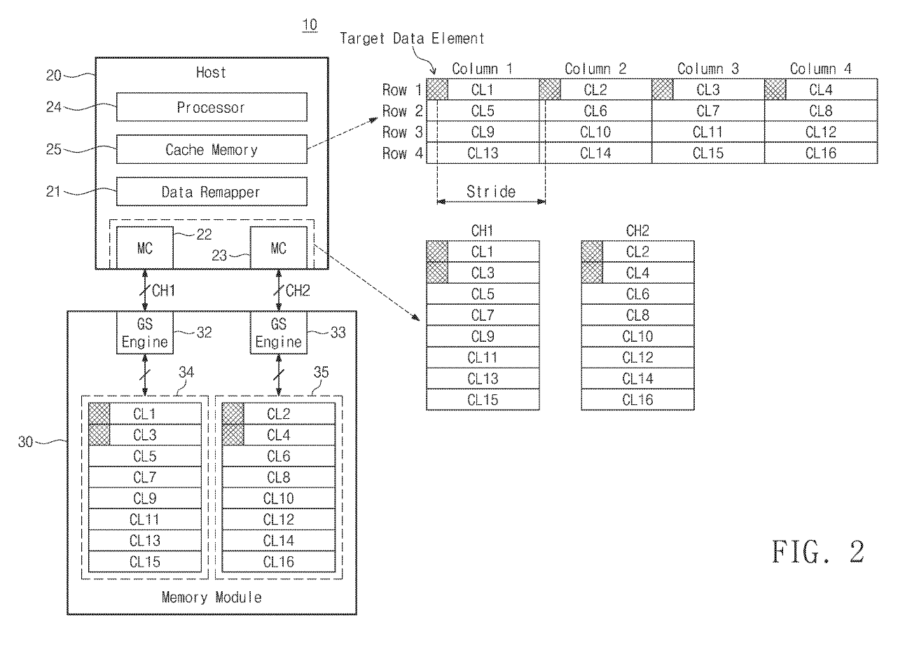

Data input/output between the host 20 and the memory module 30 may be performed by a data stream in units of a cache line. The host 20 may read frequently used data together with pieces of data close to the frequently used data from the memory' module 30 in consideration of data locality. A data unit by which the host 20 reads data from the memory module 30 may be called a cache line. The host 20 may store a cache line in an internal cache memory (not illustrated) (to be described in FIG. 2) and may process data quickly by using the cache memory. The cache line may mean a virtual space of the cache memory, in which data is stored. In addition, the host 20 may need a new cache line instead of a previous cache line stored in the cache memory. Accordingly, to back up the previous cache line, the host 20 may transfer the previous cache line to the memory module 30. In general, the size of the cache line may be 32 bytes, 64 bytes, 128 bytes, or the like. However, example embodiments of the inventive concepts are not limited by the above-described numerical values.

The memory controllers 22 and 23 may drive the memory module 30. In more detail, each of the memory controllers 22 and 23 may output a command for controlling the memory module 30 and data to the memory module 30. Referring to FIG. 1, the memory controller 22 may be connected with the gather-scatter engine 32. The memory controller 23 may be connected with the gather-scatter engine 33. Although not illustrated in FIG. 1, the number of memory controllers included in the host 20 may increase as the number of channels increases.

The memory module 30 may exchange data with the host 20. The memory module 30 may operate as a main memory, a working memory, a buffer memory, or a storage memory of the computer system 10.

The memory module 30 may include a plurality of memory devices (not illustrated). Each of the memory devices may include a plurality of memory cells (not illustrated). Each memory cell may be a volatile memory cell. For example, each memory cell may be a dynamic random access memory (DRAM) cell, a static random access memory (SRAM) cell, or the like. Each memory cell may be a non-volatile memory cell. For example, each memory cell may be a NOR flash memory cell, a NAND flash memory cell, a ferroelectric random access memory (FRAM) cell, a phase change random access memory (PRAM) cell, a thyristor random access memory (TRAM) cell, a magnetic random access memory (MRAM) cell, or the like.

Referring to FIG. 1, the memory module 30 may include the two gather-scatter engines 32 and 33 that are respectively connected with the two channels CH1 and CH2. Although not illustrated in FIG. 1, the number of gather-scatter engines may increase as the number of channels increases. That is, the memory module 30 may include gather-scatter engines that respectively correspond to a plurality of channels,

Under control of the host 20, each of the gather-scatter engines 32 and 33 may scatter data received through a channel and may store the scattered data in an internal storage of the memory module 30. Under control of the host 20, each of the gather-scatter engines 32 and 33 may gather scattered data from the internal storage of the memory module 30 and may transfer the gathered data to the host 20 through a channel.

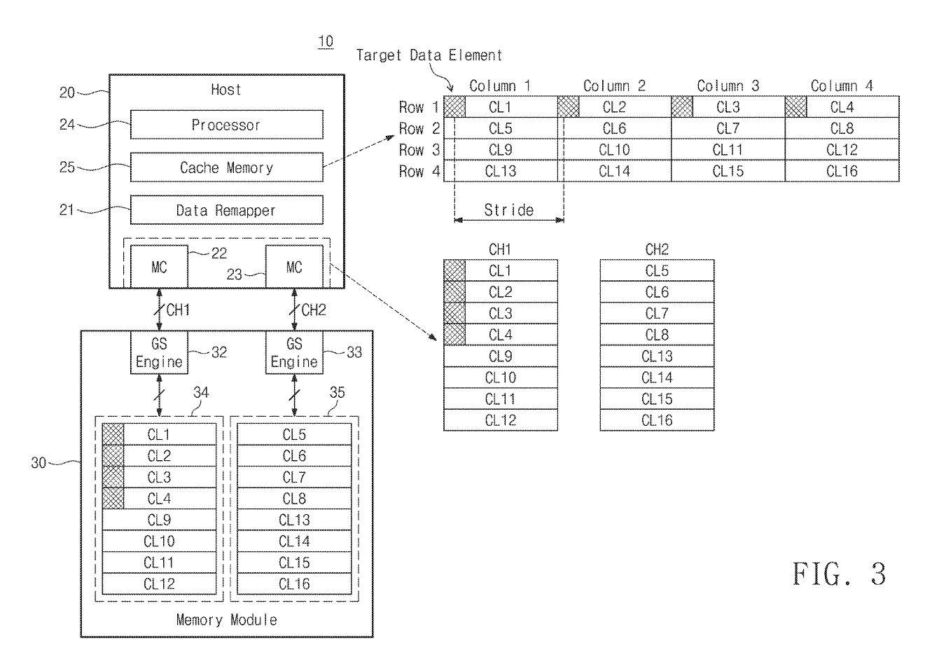

An operation in which data is exchanged between the host 20 and the memory module 30 will be described with reference to FIGS. 2 and 3. FIGS. 2 and 3 are drawings illustrating a data input/output operation performed in a computer system illustrated in FIG. 1. Unlike that illustrated in FIG. 1, the host 20 may further include a processor 24 and a cache memory 25. The memory module 30 may further include first and second memory areas 34 and 35. Below, the data input/output operation will be described after describing the additional elements (the processor 24, the cache memory 25, and the first and second memory areas 34 and 35).

The processor 24 may control overall operations of elements included in the computer system 10. The processor 24 may process data. Data that are frequently used by the processor 24 may be stored in the cache memory 25. The cache memory 25 may be used to reduce a speed difference between the processor 24 and the memory module 30. As described above, the cache memory 25 may include cache lines that are virtual storage spaces.

Each of the first and second memory areas 34 and 35 may include a plurality of memory devices (not illustrated). The memory devices included in the first memory area 34 and the memory devices included in the second memory area 35 may operate independently of each other. That is, the memory devices included in the first memory area 34 may perform data input/output with the host 20 through the first channel CH1. The memory devices included in the second memory area 35 may perform data input/output with the host 20 through the second channel CH2.

Referring to FIGS. 2 and 3, the cache memory 25 may store 16 cache lines CL1 to CL16, Each of the cache lines CL1 to CL16 may be composed of data elements. For example, the size of a cache line may be 64 bytes and the size of a data element may be 2 bytes. In this case, the cache line may be composed of 32 (=64 bytes/2 bytes) data elements. Since the number of cache lines CL1 to CL16 is 16, the 16 cache lines CL1 to CL16 may be arranged in a four-by-four data matrix. However, the number of cache lines, the number of data elements, and a matrix configuration are not limited to an example illustrated in FIGS. 2 and 3.

The processor 24 may need data elements that are continuously arranged within a stream of data including cache lines. In this case, if the processor 24 reads data in units of a cache line, the processor 24 may obtain necessary data elements at a time. Accordingly, when the processor 24 accesses continuously arranged data elements, the processor 24 may efficiently process data.

However, in some cases, the processor 24 may also need data elements that are not continuously arranged. In more detail, the processor 24 may access data elements that are arranged by a stride interval. The stride interval is a regular interval of data between consecutive target data elements in the stream of data. Referring to FIGS. 2 and 3, there are shaded data elements of data elements that are arranged in the respective cache lines CL1 to CL16. The shaded data elements may be arranged to be scattered by a stride interval. The processor 24 may access the shaded data elements. The processor 24 may access the remaining data elements not illustrated in FIGS. 2 and 3 by a stride interval. To distinguish the shaded data elements from other data elements, the shaded data elements (i.e., data elements that the processor 24 accesses by a stride interval) are referred to as “target data elements”. To access the target data elements, the processor 24 may read a stream of data including all cache lines CL1 to CL4 each of which includes the target data element and may perform an operation of gathering the target data elements from the cache lines CL1 to CL4.

In short, when the target data elements belong to one cache line because of a small stride, the processor 24 may efficiently process data. However, when the target data elements are scattered and arranged in a plurality of cache lines because of a large stride, the processor 24 may inefficiently process data compared to that described above. Accordingly, to improve the performance of the processor 24, the memory module 30 may include the gather-scatter engines 32 and 33 that gather the target data elements and transfer the gathered target data elements to the host 20. Also, to improve the performance of the processor 24, the host 20 may include the data remapper 21.

In more detail, the gather-scatter engines 32 and 33 may receive a gather command or a scatter command from the host 20 and may process the received command. When receiving the gather command from the host 20, the gather-scatter engines 32 and 33 may gather target data elements that the host 20 needs and may transfer the gathered target data elements to the host 20. When receiving the scatter command from the host 20, the gather-scatter engines 32 and 33 may scatter and store target data elements in the internal storage of the memory module 30. If the memory module 30 fails to process the gather command or the scatter command, the host 20 may generate a plurality of commands for processing each of target data elements. That is, in the case where the memory module 30 includes a gather-scatter engine, the host 20 may process target data elements at a time through the gather command or the scatter command. Below, an operation that is performed in the data remapper 21 after the host 20 generates the scatter command will be described.

Referring to FIG. 2, the data remapper 21 may allocate a plurality of cache lines CL1, CL3, CL5, CL7, CL9, CL11, CL13, and CL15 to the first channel CH1 and may allocate a plurality of cache lines CL2, CL4, CL6, CL8, CL10, CL12, CL14, and CL16 to the second channel CH2. That is, the data remapper 21 may allocate a plurality of cache lines in an interleaving way. Target data elements may be d to the first and second channels CH1 and CH2 so as to be scattered.

In contrast, referring to FIG. 3, the data remapper 21 may allocate a plurality of cache lines CL1, CL2, CL3, CL4, CL9, CL10, CL11, and CL12 to the first channel CH1 and may allocate a plurality of cache lines CL5, CL6, CL7, CL8, CL13, CL14, CL15, and CL16 to the second channel CH2. Unlike the case of FIG. 2, all target data elements may be allocated to the first channel CH1. Although not illustrated in FIG. 3, all target data elements may be allocated to the second channel CH2.

Referring to FIGS. 2 and 3, a plurality of cache lines allocated to the first channel CH1 may be stored in the first memory area 34, and a plurality of cache lines allocated to the second channel CH2 may be stored in the second memory area 35. For ease of illustration, a plurality of cache lines are illustrated as being stored in a memory area continuously in line. Unlike illustration, a plurality of cache lines may be stored in distributed memory devices of a memory area.

The processor 24 may transfer the gather command to the memory module 30 to obtain necessary target data elements. Each of the gather-scatter engines 32 and 33 may read data in units of a cache line and may gather target data elements. As illustrated in FIG. 2, in the case where target data elements are stored in the first and second memory areas 34 and 35, the host 20 may receive target data elements by occupying all the first and second channels CH1 and CH2.

In contrast, as illustrated in FIG, 3, in the case where target data elements are stored only in the first memory area 34, the host 20 may receive target data elements by occupying only the first channel CH1. Since the second channel CH2 is not occupied, the host 20 may transfer an additional command to the memory module 30 through the second channel CH2. That is, a way to allocate cache lines to a channel illustrated in FIG. 3 may be efficient compared to a way to allocate cache lines to channels illustrated in FIG. 2.

The host 20 according to an example embodiment of the inventive concepts may allocate a plurality of cache lines, in which target data elements are included, to one channel through the data remapper 21. The host 20 may transfer an additional command to the memory module 30 through another channel, to which the gather command or the scatter command is not allocated.

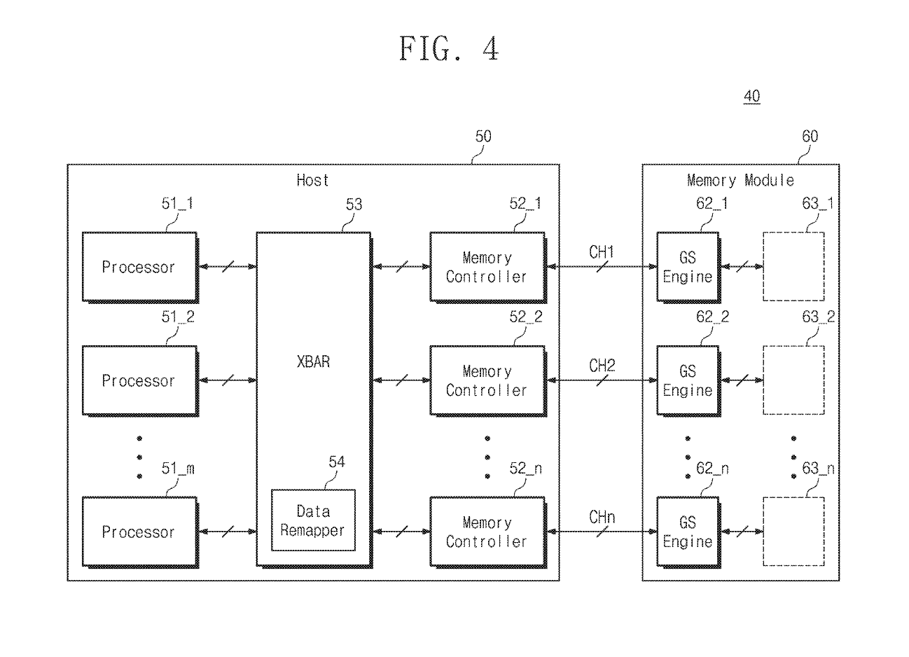

FIG. 4 is a block diagram illustrating a computer system,according to an example embodiment of the inventive concepts. Referring to FIG. 4, a computer system 40 may include a host 50 and a memory module 60. The host 50 may include a plurality of processors 51_1 to 51_m, a plurality of memory controllers 52_1 to 52_n, and a crossbar (XBAR) 53. The memory module 60 may include a plurality of gather-scatter engines 62_1 to 62_n and a plurality of memory areas 63_1 to 63_n. The crossbar 53 may include a data remapper 54. Unlike the host 20 illustrated in FIGS. 1 to 3, the host 50 may further include the plurality of processors 51_1 to 51_m and the crossbar 53. The remaining elements are described with reference to FIGS. 1 to 3, and a description thereof is thus omitted.

The host 50 may include the plurality of processors 51_1 to 51_m. Here, “m” indicates the number of processors included in the host 50. The performance of the computer system 40 may be improved more and more as “m” becomes larger. The processors 51_1 to 51_m may operate independently of each other or may operate in connection with each other. For example, some processors of the processors 51_1 to 51_m may be CPUs, and some of the other processors may be GPUs.

The crossbar 53 may be arranged between the processors 51_1 to 51_m and the memory controllers 52_1 to 52_n. Here, values of “m” and “n” may be the same or may be different from each other. The crossbar 53 may function as a switch that connects the processors 51_1 to 51_m and the memory controllers 52_1 to 52_n. Referring to FIG. 4, the crossbar 53 r ray include the data remapper 54. Although not illustrated in FIG. 4, the data remapper 54 may be arranged on the outside of the crossbar 53.

According to an example embodiment of the inventive concepts, any processor of the processors 51_1 to 51_m may occupy any one channel of a plurality of channels CH1 to CHn to read target data elements (refer to FIGS. 2 and 3). In this case, the remaining processors may occupy the remaining channels to perform data input/output with the memory module 60. That is, the example embodiments of the inventive concepts may be applied to both the case where the host 50 includes one processor and the case where the host 50 includes two or more processors.

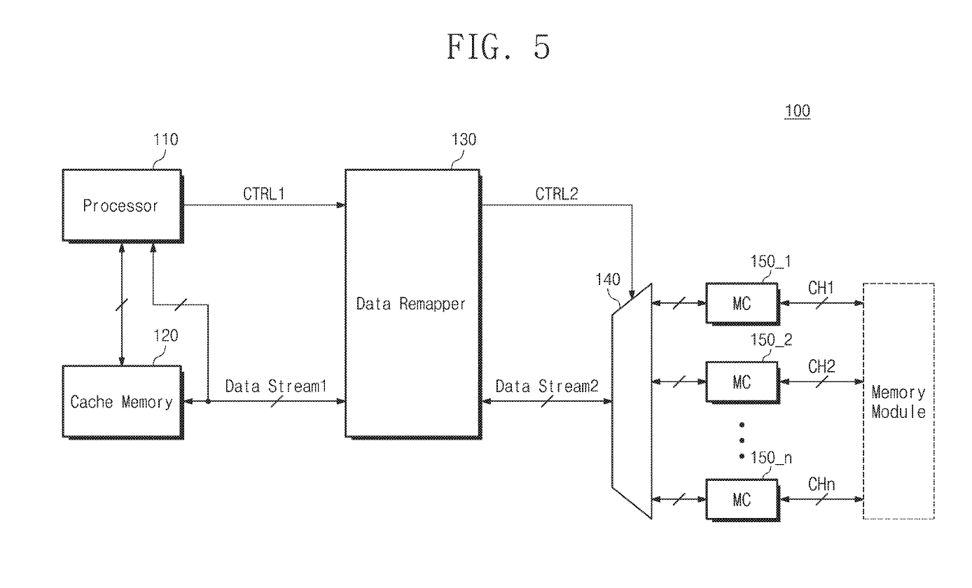

FIG. 5 is a block diagram illustrating a host, according to an example embodiment of the inventive concepts. Referring to FIG. 5, a host 100 may include a processor 110, a cache memory 120, a data remapper 130, a multiplexer 140, and a plurality of memory controllers 150_1 to 150_n. Functions of the processor 110, the cache memory 120, the data remapper 130, and the plurality of memory controllers 150_1 to 150_n are mostly the same as those described with reference to FIGS. 1 to 4.

The processor 110 may control the cache memory 120. The processor 110 may read frequently used data from the cache memory 120 in units of a cache line. In contrast, the processor 110 may store frequently used data in the cache memory 120 in units of a cache line. Also, the processor 110 may back up data, which is not frequently used any more, from the cache memory 120 to a memory module. In addition to the above-described cases, the cache memory 120 may transfer first data stream Data Stream1 to the memory module under control of the processor 110.

The processor 110 may control the data remapper 130 through a first control signal CTRL1. The first control signal CTRL1 may include information about the size of a data element, the size of a cache line, a stride value, a plurality of channels, or the like. In addition, the first control signal CTRL1 may further include identification information for identifying data that are exchanged between the host 100 and the memory module.

When the processor 110 generates the scatter command, the data remapper 130 may convert the first data stream Data Stream1 into second data streamData Stream2 in response to the first control signal CTRL1. In more detail, the data remapper 130 may remap cache lines in which target data elements (refer to FIGS. 2 and 3) are included. That is, the second data stream Data Stream2 may be a result of remapping the first data stream Data Stream 1.

When the processor 110 generates the gather command, the data remapper 130 may convert the second data stream Data Stream2 into the first data stream Data Stream1 in response to the first control signal CTRL1. In more detail, the data remapper 130 may convert the second data streamData Stream2 into the first data stream Data Stream1 with reference to the above-described remapping information. The converted first data stream Data Stream1 may be transferred to the processor 110 or the cache memory 120.

Although not illustrated in FIG. 5, the data remapper 130 may process the first and second data stream Data Stream1 and Data Stream2 in the multiplexer 140. In this case, the data remapper 130 may not directly receive the first and second data stream Data Stream1 and Data Stream2.

The multiplexer 140 may select at least one of the memory controllers 150_to 150_n in response to a second control signal CTRL2. Here, the second control signal CTRL2 may be generated by the data remapper 130. In more detail, when the processor 110 generates the scatter command, the multiplexer 140 may select any memory controller to allocate cache lines in which target data elements are included. Also, the multiplexer 140 may select any other memory controller to which the remaining cache lines other than the cache lines, in which target data elements are included, are allocated. When the processor 110 generates the gather command, the multiplexer 140 may select any memory controller to receive cache lines composed of target data elements. In this case, also, the multiplexer 140 may select any other memory controller to which the remaining cache lines are allocated.

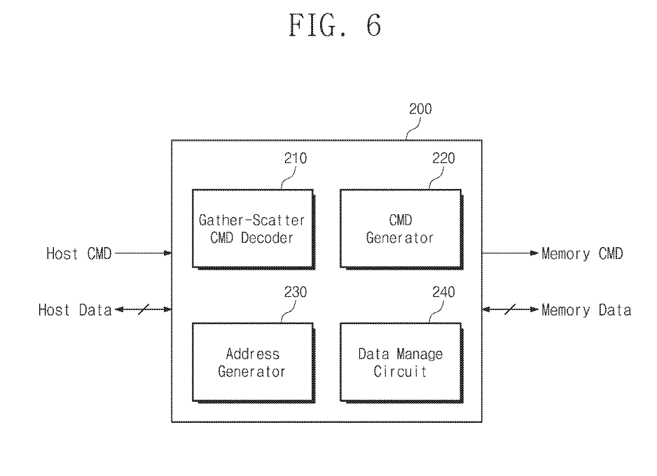

FIG. 6 is block diagram illustrating a gather-scatter engine illustrated in FIGS. 1 to 4. Referring to FIG. 6, a gather-scatter engine 200 may include a gather-scatter command decoder 210, a command generator 220, an address generator 230, and a data manage circuit 240. FIG. 6 will be described with reference to FIGS. 1 to 3.

The gather-scatter command decoder 210 may receive a host command. The gather-scatter command decoder 210 may decode the gather command or the scatter command of the host command. The gather-scatter command decoder 210 may transfer the decoding result to the command generator 220, the address generator 230, and the data manage circuit 240.

The command generator 220 may generate a memory command used in a memory module with reference to the decoding result of the gather-scatter command decoder 210. In more detail, when the gather-scatter command decoder 210 decodes the scatter command, the command generator 220 may generate a plurality of write commands. Here, the number of write commands may be determined with reference to the scatter command and cache lines transferred to the gather-scatter engine 200 together with the scatter command. An interval between write commands may be determined in consideration of the address generator 230 and the memory module. When the gather-scatter command decoder 210 decodes the gather command, the command generator 220 may generate a plurality of read commands. Here, the number of read commands may be determined with reference to cache lines that will be transferred to the host 20 (refer to FIGS. 1 to 3. An interval between read commands may be determined in consideration of the address generator 230 and the memory module.

The address generator 230 may generate a memory address (not illustrated) used in the memory module with reference to the decoding result of the gather-scatter command decoder 210, in more detail, an interval between addresses generated by the address generator 230 may be determined with reference to a stride interval. For example, an interval between addresses generated by the address generator 230 may be the same as the stride interval. Although not illustrated in FIG. 6, the memory address may be included in the memory command. The memory address may include a row address, a column address, a bank address, etc. of a memory,

In more detail, the address generator 230 may directly receive a stride value from the host 20 or may receive the stride value through the gather-scatter command decoder 210. The address generator 230 may generate a memory address with reference to the received stride value. That is, the address generator 230 may assign a memory address to each of target data elements. To this end, the address generator 230 may include a counter (not illustrated) that counts a stride value, a counter (not illustrated) that counts any address, etc.

The data manage circuit 240 may function as a data buffer between the host 20 (refer to FIGS. 1 to 3) and the memory module 30 (refer to FIGS. 1 to 3). In more detail, when the gather-scatter command decoder 210 decodes the scatter command, the data manage circuit 240 may store target data elements. Afterwards, the data manage circuit 240 may output target data elements to the memory module 30 correspond to the write commands. When the gather-scatter command decoder 210 decodes the gather command, the data manage circuit 240 may gather and store target data elements. Afterwards, the data manage circuit 240 may merge the stored target data elements into a cache line and may transfer the cache line to the host 20.

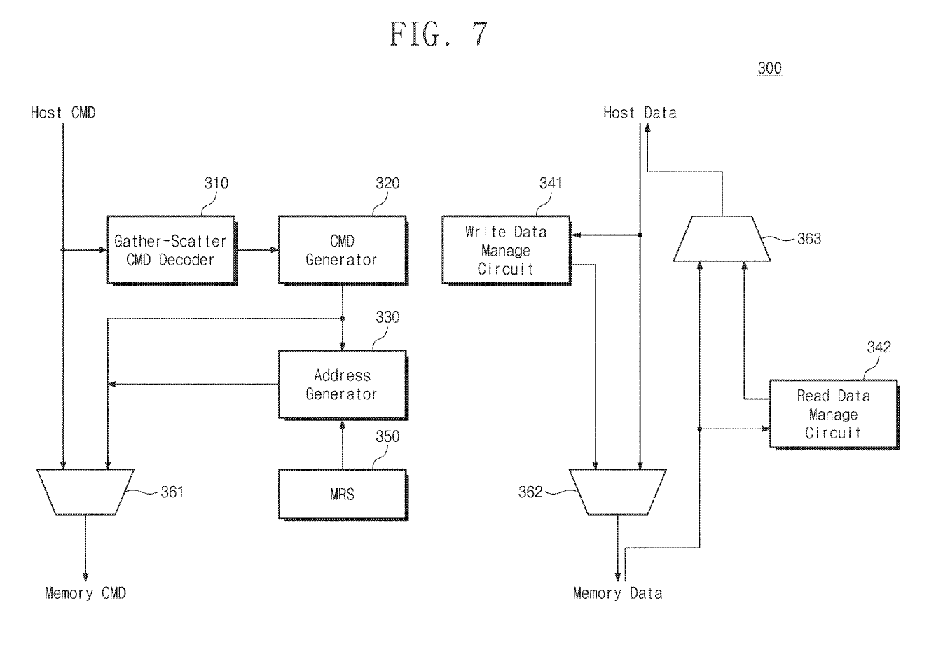

FIG. 7 is a block diagram illustrating a detailed example embodiment of a gather-scatter engine illustrated in FIG. 6. Referring to FIG. 7, a gather-scatter engine 300 may include a gather-scatter command decoder 310, a command generator 320, an address generator 330, a write data manage circuit 341, a read data manage circuit 342, a mode register set (MRS) 350, and first to third multiplexers 361 to 363. Functions of the gather-scatter command decoder 310, the command generator and the address generator 330 may be mostly the same as those described with reference to FIG. 6.

The write data manage circuit 341 may be included in the data manage circuit 240 described with reference to FIG. 6. The write data manage circuit 341 may store target data elements. Afterwards, the write data manage circuit 341 may output target data elements to the second multiplexer 362 in response to a write command. The write data manage circuit 341 y operate while the gather-scatter engine 300 processes the scatter command.

The read data manage circuit 342 may be included in the data manage circuit 240 described with reference to FIG. 6. The read data manage circuit 342 may gather and store target data elements. Afterwards, the read data manage circuit 342 may merge the stored target data elements into a cache line and may transfer the cache line to the host 20. The read data manage circuit 342 may operate while the gather-scatter engine 300 processes the gather command.

The mode register set 350 may be connected with the address generator 330. The mode register set 350 may include a plurality of registers (not illustrated). The mode register set 350 may provide the address generator 330 with information that is needed to generate an address. For example, the host 20 may store a stride value in the mode register set 350 in advance. Alternatively, the host 20 may change a stride value stored in the mode register set 350.

The first multiplexer 361 may transfer any one of a host command or a command generated by the command generator 320 to a memory module. The first multiplexer 361 may just transfer the host command to the memory module. Alternatively, the first multiplexer 361 may transfer a command generated by the command generator 320 to the memory module while the gather-scatter engine 300 processes the scatter command or the gather command. In this case, the first multiplexer 361 may also transfer an address generated by the address generator 330 to the memory module.

The second multiplexer 362 may transfer any one of host data or data generated by the write data manage circuit 341 to the memory module. Here, the host data may mean data that are transferred from the host 20 to the memory module. The second multiplexer 362 may just transfer the host data to the memory module. Alternatively, the second multiplexer 362 may transfer data generated by the write data manage circuit 341 to the memory module while the gather-scatter engine 300 processes the scatter

The third multiplexer 363 may transfer any one of memory data or data generated by the read data manage circuit 342 to the host 20. Here, the memory data may mean data that are read from memory devices of the memory module. The third multiplexer 363 may just transfer the memory data to the host 20. Alternatively, the third multiplexer 363 may transfer data generated by the data manage circuit 342 to the host 20 while the gather-scatter engine 300 processes the gather command.

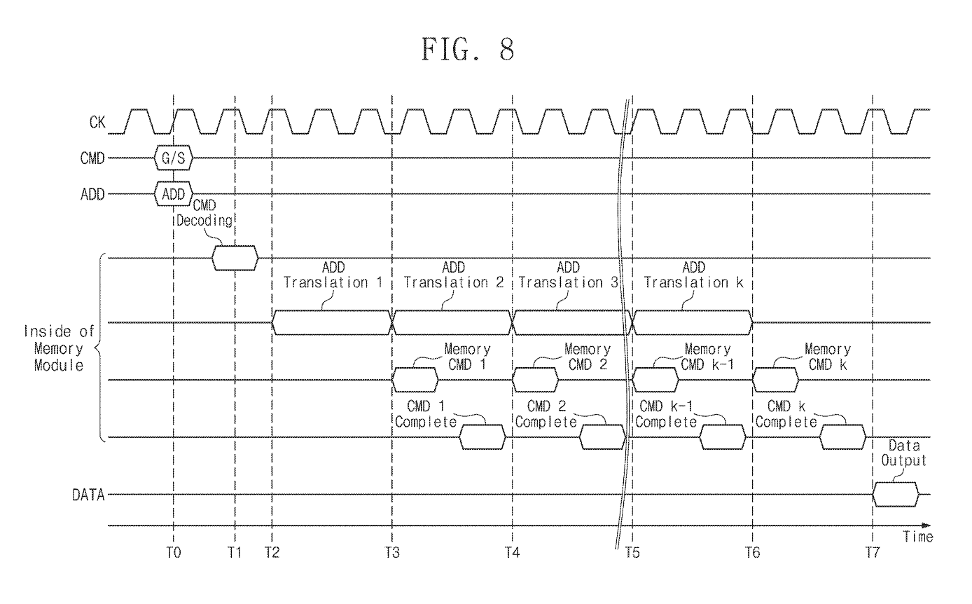

FIG. 8 is a timing diagram illustrating an operation in which a memory module processes a gather-scatter command, according to an example embodiment of the inventive concepts. FIG. 8 will be described with reference to FIGS. 2, 3, and 6.

At a point in time TO, the gather-scatter engine 200 may receive a gather command or scatter command (i/S from the host 20. In addition, the memory module 30 may receive an address ADD from the host 20. In this case, the gather command, the scatter command, and the address may be transferred in synchronization with a clock CK.

At a point in time T1, the gather-scatter engine 200 may perform command decoding. In more detail, the gather-scatter command decoder 210 may decode the gather command or the scatter command received at the point in time T0.

At a point in time T2, the gather-scatter engine 200 may perform first address translation ADD Translation 1. Here, the address translation means that the address generator 230 newly generates a memory address with reference to the gather command, the scatter command, and the address received at the point in time T0.

At a point in time T3, the gather-scatter engine 200 may terminate the first address translation ADD translation 1. . In succession, the gather-scatter engine 200 may perform second address translation ADD translation 2. The gather-scatter engine 200 may transfer a translated first address and a first memory command Memory CMD 1 corresponding to the translated first address to the memory module. Here, the first memory command Memory CMD 1 may be a write command when the gather-scatter engine 200 receives the scatter command and may be a read command when the gather-scatter engine 200 receives the gather command. Although not illustrated in FIG. 8, write data may be generated together when the gather-scatter engine 200 generates the write command. Here, the write data may be composed of some data elements of target data elements. That is, the gather-scatter engine 200 may transfer the write command and the write data to the memory module. Between a point in time T3 and a point in time T4, an operation of the memory module, which is performed according to the first memory command Memory CMD 1, may be completed. However, a complete point in time is not limited to illustration.

At the point in time T4, operations described at the point in tune T3 may be repeatedly performed. At a point in time T5, the gather-scatter engine 200 may perform k-th address translation ADD translation k. Here, “k” may be determined according to a specification between the host 20 and the memory module 30, the stride value, the size of a cache line, the size of data elements, or the like. At a point in time T5, the gather-scatter engine 200 may transfer a translated (k-1)-th address and a (k-1)-th memory command Memory CMD k-1 corresponding to the translated (k-1)-th address to the memory module. Between a point in time T5 and a point in time T6, an operation of the memory module, which is performed according to the (k-1)-th memory command Memory CMD k-1, may be completed. However, a complete point in time is not limited to illustration.

At a point in time T6, the gather-scatter engine 200 may terminate the k-th address translation ADD translation k. The gather-scatter engine 200 may transfer a translated k-th address and a k-th memory command Memory CMD k corresponding to the translated k-th address to the memory module. Afterwards, an operation of the memory module, which is performed according to the k-th memory command Memory CMD k-1, may be completed.

If the gather-scatter 200 receives the gather command from the host 20, at a point in time T7, the gather-scatter engine 200 may output data, that is, a cache line to the host 20. As described above, the cache line may be composed of target data elements.

According to an example embodiment of the inventive concepts, the host 20 may only transfer the gather command or the scatter command to the memory module 30 at the point in time T0 for input/output of target data that will be accessed by a stride interval. That is, an additional command for input/output of target data is not needed from the point in time T0 to the point in time T7. That is, the host 2s may perform any other normal operations from the point in time T0 to the point in time T7.

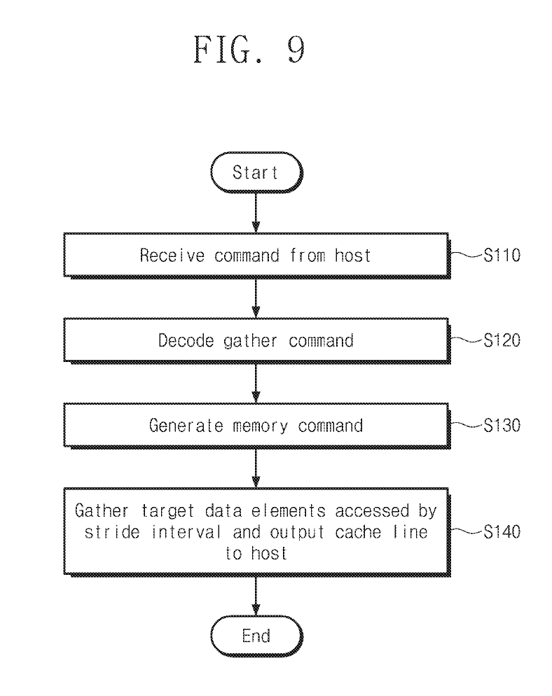

FIG. 9 is a flowchart illustrating an operation sequence of a memory module, according to an example embodiment of the inventive concepts. FIG. 9 will he described with reference to FIGS. 3 and 8.

In operation S110, the memory module 30 may receive a gather command or a scatter command from the host 20. In more detail, one of the gather-scatter engines 32 and 33 included in the memory module 30 may receive the gather command or the scatter command. Operation S110 may correspond to an operation at the point in time T0 of FIG. 8.

In operation S120, the gather-scatter engine 32 or 33 may decode the gather command. If the host 20 generates a command different from the gather command or the scatter command, the gather-scatter engine 32 or 33 may just transfer the command generated by the host 20 to the memory module 30. Operation S120 may correspond to an operation at the point in time T1 of FIG, 8.

In operation S130, the gather-scatter engine 32 or 33 may generate the memory command based on a result of decoding the gather command. For example, the memory command may be a read command. Also, the gather-scatter engine 32 or 33 may generate a memory address corresponding to the memory command. Operation S130 may correspond to an operation from the point in time T2 to the point in time T6 of FIG. 8.

In operation S140, the gather-scatter engine 32 or 33 may gather target data elements that are accessed by a stride interval. In more detail, the gather-scatter engine 32 or 33 may gather data read out from the memory module 30 through the read command. Afterwards, the gather-scatter engine 32 or 33 may output a cache line to the host 20. Here, the cache line may be composed of target data elements that are accessed by a stride interval by the gather-scatter engine 32 or 33. Operation S140 may correspond to an operation at the point in time T7 of FIG. 8.

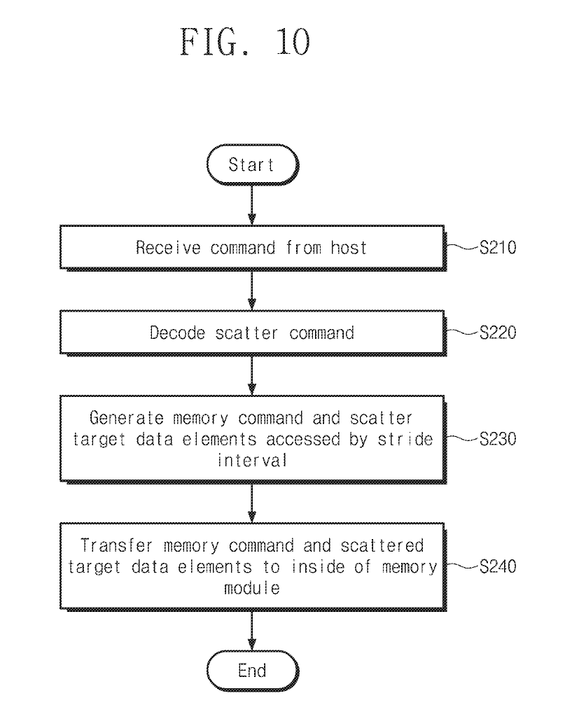

FIG. 10 is a flowchart illustrating an operation sequence of a memory module, according to an example embodiment of the inventive concepts. FIG. 10 will be described with reference to FIGS. 3 and 8.

In operation S210, the memory module 30 may receive a scatter command from the host 20. In more detail, one of the gather-scatter engines 32 and 33 included in the memory module 30 may receive the scatter command. Operation S210 may correspond to an operation at the point in time TO of FIG. 8.

In operation S220, the gather-scatter engine 32 or 33 may decode the scatter command. Operation S220 may correspond to an operation at the point in time T1 of FIG. 8.

In operation S230, the gather-scatter engine 32 or 33 may generate the memory command based on the decoding result of the scatter command. For example, the memory command may be a write command. The gather-scatter engine 32 or 33 may also generate a memory address corresponding to the memory command. The gather-scatter engine 32 or 33 may scatter target data elements that are accessed by a stride interval. In more detail, the gather-scatter engine 32 or 33 may scatter target data elements to be accessed by a stride interval, based on the memory command. Operation S230 may correspond to an operation from the point in time T2 to the point in time T6 of FIG. 8.

In operation S240, the gather-scatter engine 32 or 33 may transfer the memory command generated in operation S230 and the scattered target data elements to the memory module 30. Operation S240 may correspond to an operation from the point in time T2 to the point in tune 17 of FIG, 8.

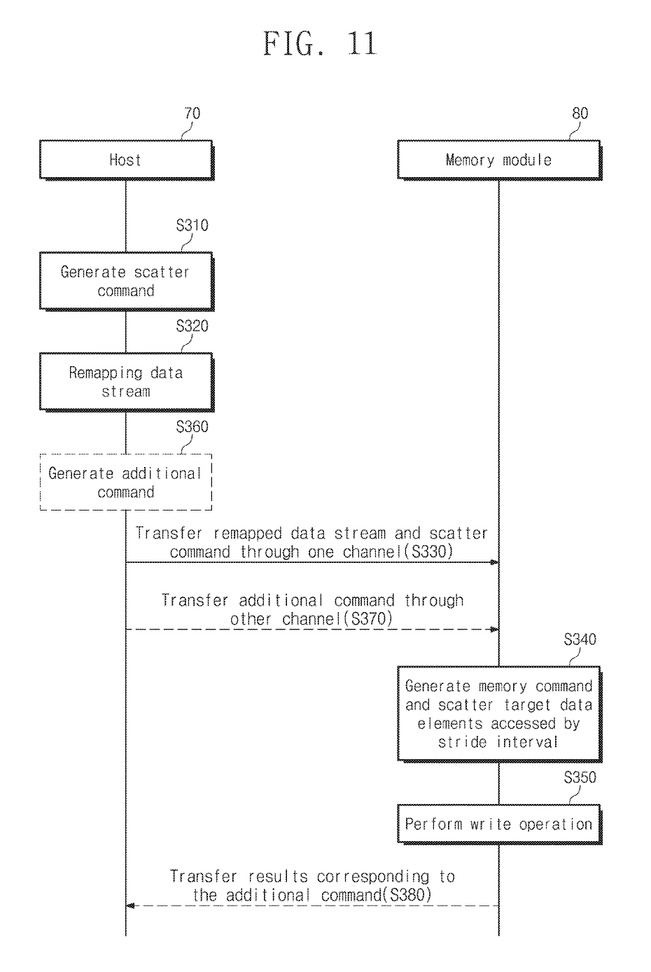

FIG. 11 is a drawing illustrating an operation in which a scatter command is performed in a computer system, according to an example embodiment of the inventive concepts. FIG. 11 will be described with reference to FIG. 10.

In operation S310, a host 70 may generate a scatter and.

In operation S320, the host 70 may remap a data stream. In this case, the host 70 may allocate a plurality of cache lines, in which target data elements to be accessed by a stride interval are included, to one channel. The host 70 may allocate the remaining cache lines to other channels.

In operation S330, the host 70 may transfer the remapped data stream and the scatter command to a memory module 80 through one channel. According to an example embodiment of the inventive concepts, the cache lines in which target data elements are included may be transferred through one channel. Operation S330 may correspond to operation S210 of FIG. 10.

In operation S340, the memory module 80 may generate a memory command with reference to the received command. The memory module 80 may scatter target data elements to be accessed by a stride interval. Operation S340 may correspond to operation 5230 of FIG, 10.

In operation S350, the memory module 80 may perform a write operation. In more detail, the memory module 80 may store the target data elements scattered in operation S340 therein. Operation S350 may correspond to operation S240 of FIG. 10.

In operation S360 and operation S370, the host 70 may generate an additional command and may transfer the additional command to the memory module 80. In operation 5380, the host 70 may receive results corresponding to the additional command from the memory module 80. Here, the additional command may be a scatter command that is different from the scatter command generated in operation S310 or may be a command for performing any other operation. In FIG. 11, since operation S360, operation S370, and operation S380 may be performed or may not be performed, they are illustrated by dotted lines. Points in time at which operation S360, operation S370, and operation S380 are respectively performed are not limited to illustration. According to an example embodiment of the inventive concepts, the scatter command generated in operation S310 may be transferred through one channel of a plurality of channels. Accordingly, the host 70 may use the memory module 80 through the remaining channels.

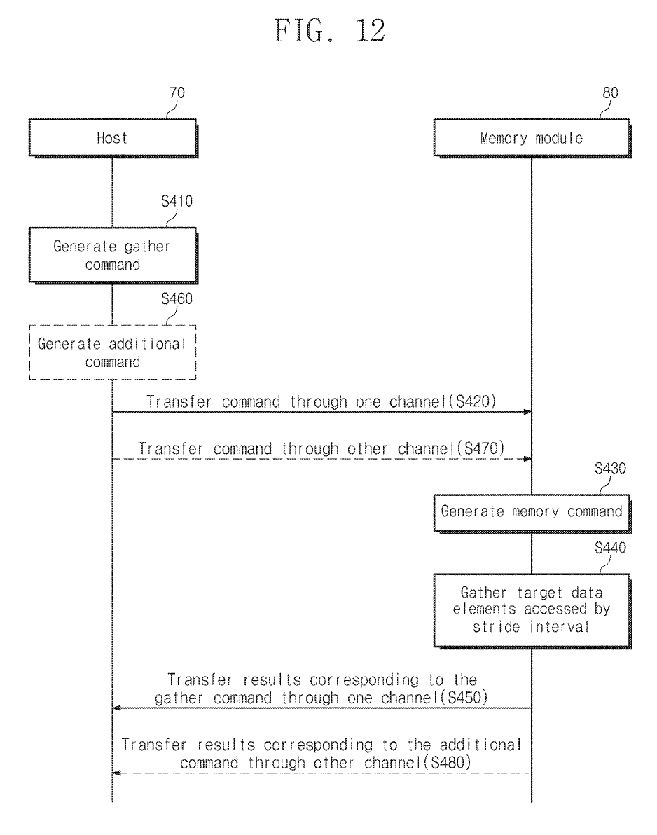

FIG. 12 is a drawing illustrating an operation in which a gather command is performed in a computer system, according to an example embodiment of the inventive concepts. FIG. 12 will be described with reference to FIG. 9.

In operation S410, the host 70 may generate a gather command.

In operation S420, the host 70 may transfer the gather command to the memory module 80. Target data elements to be accessed by a stride interval have been previously stored in the memory module 80 through one channel. Accordingly, the host 70 may transfer the gather command to only one channel, not a plurality of channels. Operation S420 may correspond to operation S110 of FIG. 9.

In operation S430, the memory module 80 may generate a memory command with reference to the received command. Operation S430 may correspond to operation S130 of FIG. 9.

In operation S440, the memory module 80 may gather target data elements to be accessed by a stride interval. In more detail, the memory module 80 may perform a read operation. Operation S440 may correspond to operation S140 of FIG. 9.

In operation S450, the memory module 80 may transfer a result corresponding to the gather command to the host 70. Here, the result corresponding to the gather command may mean target data elements gathered in operation S440. The result corresponding to the gather command may be transferred to the host 70 through one channel. The remaining channels may be used for the host 70 to transfer an additional command to the memory module 80 or to receive a result of the memory module 80, which corresponds to the additional command.

In operation S460 and operation S470, the host 70 may generate an additional command and may transfer the additional command to the memory module 80. In operation S480, the host 70 may receive results corresponding to the additional command from the memory module 80. Here, the additional command may be a gather command that is different from the gather command generated in operation S410 or may be a command for performing any other operation. In FIG. 12, since operation S460, operation S470, and operation S480 may be performed or may not be performed, they are illustrated by dotted lines. Points in time at which operation S460, operation S470, and operation S480 are respectively performed are not limited to illustration. According to an example embodiment of the inventive concepts, the gather command generated in operation S410 may be transferred through one channel of a plurality of channels. Accordingly, the host 70 may use the memory module 80 through the remaining channels.

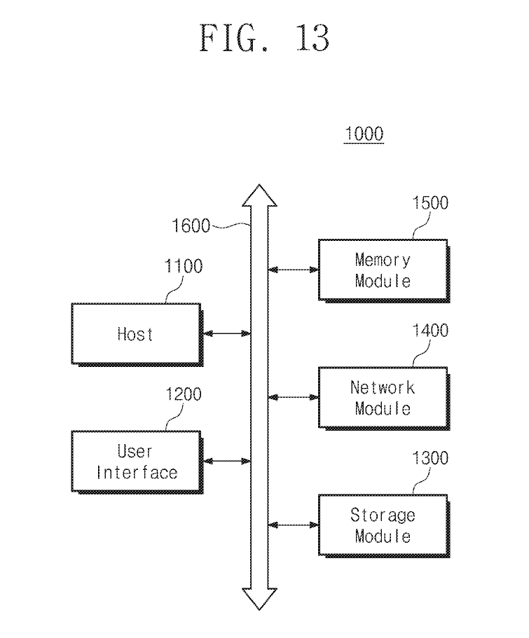

FIG. 13 is a block diagram illustrating an application of a computer system, according o an example embodiment of the inventive concepts. Referring to FIG. 13, a computer system 1000 may include a host 1100, a user interface 1200, a storage module 1300, a network module 1400, a memory module 1500, and a system bus 1600.

The host 1100 may drive elements and an operating system of the computer system 1000. In an example embodiment, the host 1100 may include controllers for controlling elements of the computer system 1000, interfaces, graphics engines, etc. The host 1100 may be a system-on-chip (SoC).

The user interface 1200 may include interfaces that input data or an instruction to the host 1100 or output data to an external device. In an example embodiment, the user interface 1200 may include user input interfaces such as a keyboard, a keypad, buttons, a touch panel, a touch screen, a touch pad, a touch ball, a camera, a microphone, a gyroscope sensor, a vibration sensor, and a piezoelectric element. The user interface 1200 may further include interfaces such as a liquid crystal display (LCD), an organic light-emitting diode (OLED) display device, an active matrix OLED (AMOLED) display device, a light-emitting diode (LED), a speaker, and a motor.

The storage module 1300 may store data. For example, the storage module 1300 may store data received from the host 1100. Alternatively, the storage module 1300 may transfer data stored therein to the host 1100. In an example embodiment, the storage module 1300 may be implemented with a nonvolatile memory device such as an electrically programmable read only memory (EPROM), a NAND flash memory, a NOR flash memory, a PRAM, a ReRAM, a FeRAM, an MRAM, or a TRAM. The storage module 1300 may be a memory module according to an example embodiment of the inventive concepts.

The network module 1400 may communicate with external devices. In an example embodiment, the network module 1400 may support wireless communications, such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless LAN (WLAN), ultra wide band (LTWB), Bluetooth, and wireless display (WI-DI).

The memory module 1500 may operate as a main memory, a working memory, a buffer memory, or a cache memory of the computer system 1000. The memory module 1500 may include volatile memories such as a DRAM and an SRAM or nonvolatile memories such as a NAND flash memory, a NOR flash memory, a PRAM., a ReRAM, a FeRAM, an MRAM, and a TRAM. The memory module 1500 may be a memory module according to an example embodiment of the inventive concepts.

The system bus 1600 may electrically connect the host 1100, the user interface 1200, the storage module 1300, the network module 1400, and the memory module 1500 to each other.

A computer system according to an example embodiment of the inventive concepts may efficiently perform data input/output that is performed in units of a cache line.

A memory device according to an example embodiment of the inventive concepts may efficiently perform data input/output through gather-scatter engines that respectively correspond to a plurality of channels.

While the inventive concepts have been described with reference to example embodiments, it will be apparent to those skilled in the art that various changes and modifications may be made without departing from the spirit and scope of the inventive concepts. Therefore, it should be understood that the above example embodiments are not limiting, but illustrative.

What is claimed is:

1. A computer system comprising:
a host configured to transfer a plurality of cache lines to a memory module through a plurality of channels, the cache lines including a plurality of data elements, the host allocating the cache lines with target data elements in the plurality of data elements to one channel of the plurality of channels, the target data elements being arranged within the cache lines according to a stride interval, the stride interval being a number of data elements between consecutive ones of the target data elements; and
the memory module comprising gather-scatter engines that are respectively connected to the plurality of channels, and the gather-scatter engines are configured to scatter or gather the target data elements under control of the host,

2. The computer system of claim I, wherein the target data elements are not continuous.

3. The computer system of claim l, wherein the host is configured to
store the target data elements in the memory module by using a scatter command, and
read the target data elements from the memory module by using a gather command.

4. The computer system of claim 3, wherein the host is configured to transfer the target data elements, using one of the scatter command, or the gather command, through the one channel of the plurality of channels.

5. The computer system of claim 1, wherein the host is configured to
transfer a gather command to the memory module through the one channel of the plurality of channels, and
transfer an additional and to the memory module through another channel of the plurality of channels.

6. The computer system of claim 1, wherein the host comprises:
a plurality of memory controllers configured to drive the memory module via the plurality of channels; and
a data remapper configured to transfer the cache lines, including the target data elements to any one memory controller of the plurality of memory controllers.

7. The computer system of claim 6, wherein the data remapper is implemented in a hardware manner o software manner.

8. The computer system of claim 6, wherein the host further comprises:
a multiplexer configured to select any one memory controller of the plurality of memory controllers under control of the data remapper.

9. The computer system of claim 6, wherein the host further comprises:
at least one cache memory configured to store the plurality of cache lines; and
at least one processor electrically connected with the at least one cache memory and configured to control the data remapper.

10. The computer system of claim 3, wherein each of the plurality of gather-scatter engines comprises:
a gather-scatter command decoder configured to decode the gather command or the scatter command of the host;
a command generator configured to generate commands for the memory module based on the gather command or the scatter command;
an address generator configured to generate addresses for the memory module based on the gather command or the scatter command; and
a data manage circuit configured to store data received from the host based on the scatter command or to store data to be transferred to the host based on the gather command.

11. A memory module comprising:
a plurality of memory areas respectively connected with a plurality of channels; and
a plurality of gather-scatter engines respectively connected with the plurality of channels and respectively connected with the plurality of memory areas, each of the plurality of gather-scatter engines is configured to
scatter target data elements through one channel of the plurality of channels such that the target data elements are stored in a memory area connected with the one channel of the plurality of channels, the target data elements are arranged according to a stride interval, the stride interval being a number of data elements between consecutive ones of the target data elements, and
transfer the target data elements to the host after gathering the target data elements from the memory area connected with the one channel of the plurality of channels.

12. The memory module of claim 11, wherein one gather-scatter engine of the plurality of gather-scatter engines is configured to
transfer the target data elements to the host after gathering the target data elements from the memory area, and
receive an additional command from the host through the remaining channels of the plurality of channels.

13. The memory module of claim 11, wherein each of the plurality of gather-scatter engines comprises:
a gather-scatter command decoder configured to decode a gather command or a scatter command of the host;
a command generator configured to generate internal commands based on the gather command or the scatter command;
an address generator configured to generate internal addresses based on the gather command or the scatter command; and
a data manage circuit configured to transfer data from the host to any one memory area of the plurality of memory areas based on the scatter command or to transfer data from the one memory area to the host based on the gather command.

14. The memory module of claim 13, wherein intervals between the plurality of internal addresses are the same as the stride interval.

15. The memory module of claim 11, wherein each of the plurality of memory areas comprises a dynamic random access memory (DRAM).

16. A computer system comprising:
a host configured to
transfer a stream of data to a memory module through a plurality of channels, the stream of data divided into cache lines, each line of the cache lines including a plurality of data elements, some of the data elements being target data elements that are dispersed among the stream of data at a regular interval, and
allocate the cache lines including the target data elements to one channel of the plurality of channels; and
the memory module including gather-scatter engines that are respectively connected to the plurality of channels, the gather-scatter engines configured to scatter the target data elements into one of a plurality of memory areas or gather the target data elements from the one of the plurality of memory areas.

17. The computer system of claim 16, wherein the host comprises:
a plurality of memory controllers configured to drive the memory module via the plurality of channels; and
a data remapper configured to transfer the cache lines, including the target data elements to one of the plurality of memory controllers.

18. The computer system of claim 17, wherein the host further comprises:
at least one cache memory configured to store the plurality of cache lines; and
at least one processor electrically connected with the at least one cache memory and configured to control the data remapper.

19. The computer system of claim 16, wherein each of the gather-scatter engines is configured to,
decode a gather command or a scatter command,
generate commands for the memory module based on the gather command or the scatter command,
generate addresses for the memory module based on the gather command or the scatter command, and
store the target data elements received from the host based on the scatter and or to store the target data elements to be transferred to the host based on the gather command.
